(19) United States
(12) Patent Application Publication
(10) Pub. No.: US 2005/0102212 A1
(43) Pub. Date: May 12, 2005

(54) Systems and methods for generating audited and unaudited financial statements and reports

(75) Inventor: Elizabeth Roy, San Diego, CA (US)

Correspondence Address: ORRICK, HERRINGTON & SUTCLIFFE, LLP, 4 PARK PLAZA, SUITE 1600, IRVINE, CA, 92614-2558, US

(73) Assignee: QD Financial, LLC

(21) Appl. No.: 10/703,742

(22) Filed: Nov. 7, 2003

(51) Int. Cl. G06F 17/60

(52) U.S. Cl. 705/36

(57) ABSTRACT

The present invention is generally directed towards systems and methods for generating audited and unaudited financial statements and reports. One embodiment is a system for generating audited and unaudited financial statements and reports. The system may extract financial data from one or more financial sources and generate financial statements with fields having associated fields. Further, the system may import the financial data into the fields of the financial statements/reports and create links between the fields and associated fields. Accordingly, when the financial statements/reports are audited and/or revised, causing the value of a field to change, all the linked fields are updated by the system.

### FIELD OF THE INVENTION

The various embodiments disclosed herein relate to auditing and managing financial documents, and more particularly to systems and methods for generating audited and unaudited financial statements and reports.

### BACKGROUND OF THE INVENTION

Publicly held companies are required to disclose specific financial information to their shareholders, the board of directors, and the SEC. The majority of privately-held companies are also required to disclose financial information, generally to the board of directors or to a lending institution from whom the company is borrowing funds. The required financial information submitted to the respective third party is typically in the form of either audited financial statements or unaudited periodic management reports.

As stated in the American Institute of Certified Public Accountants (AICPA) Auditing Standards Literature, “basic financial statements” generally include a balance sheet, an income statement, a cash flow statement, and an equity statement. In addition to these statements, companies also include supplementary information, typically footnotes that describe such things as the company's accounting policies, long-term commitments, and depreciation methods. Public companies, in order to comply with extensive SEC regulations, are required to include other means of financial reporting as well, such as the Management Discussion and Analysis (MD&A), risk factors surrounding the company's operations and assumptions, analysis reports and news articles. In addition, other parties—board of directors, management, lenders—often require detailed financial reports on a regular basis that typically reflect both budgeted and actual amounts.

The existing process to generate audited and unaudited financial statements and reports, the components of which were described above, is a manual, laborious, and repetitive activity. The basic financial data—balance sheet and income statement—is typically generated using a third party accounting software package, such as QuickBooks®, Great Plains®, Lawson® or Oracle®, and may be retrieved using either budgeted or actual balances. The balance sheet and income statement are generated by such applications and, therefore, they are not in a usable format for adding the footnotes and other required sections. As a result, the financial data in the balance sheet and income statement is either manually input or “cut and paste” into a text document, such as Microsoft Word™, and the footnotes and other supplemental sections or text are added accordingly.

Due to the vast number of tables and financial calculations embedded throughout the report and the fact that this data typically changes many times during the reporting process, the manual method of reviewing and changing associated data causes financial statement/report preparation to be considerably time-consuming and labor-intensive.

When financial statements and reports are initially prepared, either internally at the company or externally through independent auditors, the numbers are generally “soft” and subject to further revision. Since there will be many changes to the numbers before the documents are finalized, it is not unusual for 15 to 20 iterations to be produced, each of which requires manual review and modification to each section of the entire document.

Due to the interdependence of the financial statement/report balances and/or values, a change to one number typically affects all sections of the document. Furthermore, in the existing manual mode, because the data is embedded in a text format, every subtotal and total has to be manually reentered and recalculated, and the text has to be extensively reviewed. This manual process seeks to ensure that every number embedded in the notes that was dependent upon that amount or balance is appropriately changed.

These manual reports go through many revisions and, as a result, accounting personnel and auditors spend significant, billable hours processing changes and recalculating the numbers. Inevitably, due to the cumbersome nature of the process, the final document submitted is prone to mistakes, inaccuracies and inconsistencies.

Accordingly, improved systems and methods for compiling and generating audited and unaudited financial statements and reports would be desirable.

### SUMMARY OF THE INVENTION

The various embodiments disclosed herein are generally directed towards systems and methods for generating audited and unaudited financial statements and reports. One embodiment is a system for generating audited and unaudited financial statements and reports. The system may extract financial data from one or more third party software sources, or from within the system itself, and generate financial statements with fields having associated fields. Further, the system may import the financial data into the fields of the financial statements and create links between the fields and associated fields. Accordingly, when the financial statements are revised in the reporting process, and the value of a field is changed, all the linked fields are updated by the system.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the present inventions disclosed herein are obtained, a more particular description of the embodiments briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a flowchart of an existing process for compiling and generating audited and/or unaudited financial statements and/or reports.

FIG. 2a is an example of a balance sheet;

FIG. 2b is an example of an income statement;

FIG. 2c is an example of a cash flow statement;

FIG. 2d is an example of an income statement worksheet, in accordance with a preferred embodiment of the present invention;

FIG. 2e is an example of a balance sheet worksheet, in accordance with a preferred embodiment of the present invention;

FIG. 3 is a diagram of a system in accordance with a preferred embodiment of the present invention;

FIG. 4 is a flowchart of a process in accordance with a preferred embodiment of the present invention;

FIG. 5 are sample excerpts from a balance sheet and a supplemental section of a financial statement;

FIG. 6 is a diagram of a system in accordance with a preferred embodiment of the present invention; and

FIG. 7 is an example of an existing (budget vs. actual) management report.

### DETAILED DESCRIPTION OF THE PREFERRED EMBODIMENTS

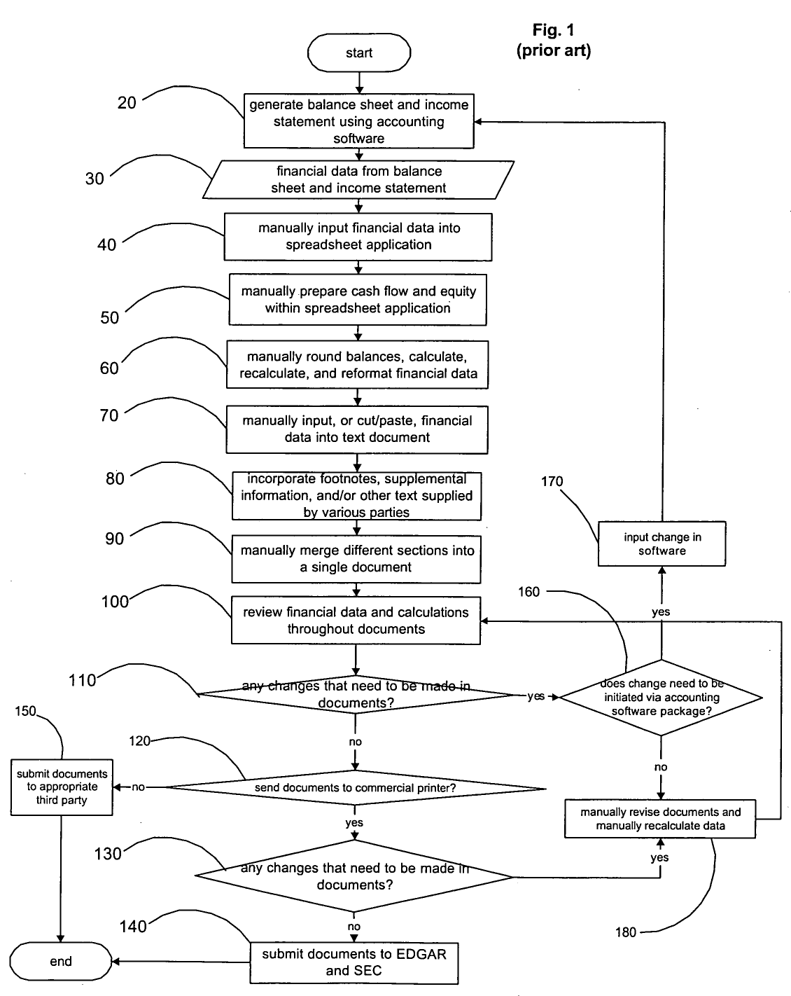

Turning to FIG. 1, a typical process for creating and compiling a set of audited and/or unaudited financial statements and/or reports is illustrated. First, financial data (data block 30)—which may be budgeted, actual, or both—is extracted from one or more balance sheets and income statements, which are generated from one or more general ledger software packages, such as QuickBooks®, Great Plains®, Lawson®, or Oracle® (action block 20). Balance sheets reflect a corporation's assets and liabilities as of a given date. Income statements show the sales, costs, and income or loss for a certain period of time. Income statements are also referred to as the “Statement of Operations” and “P&L statements.”

Next, the financial data (data block 30) is manually entered into a spreadsheet application (action block 40). Then, additional documents are manually created within the spreadsheet application, namely, cash flow statements and equity statements (action block 50) and appropriate calculations and recalculations are made (action block 60). Cash flow statements are derived from the balance sheets and income statements to reflect the company's cash flow activities from investing, financing, and operations. Equity statements reflect the investments by and distributions to owners or shareholders of the corporation.

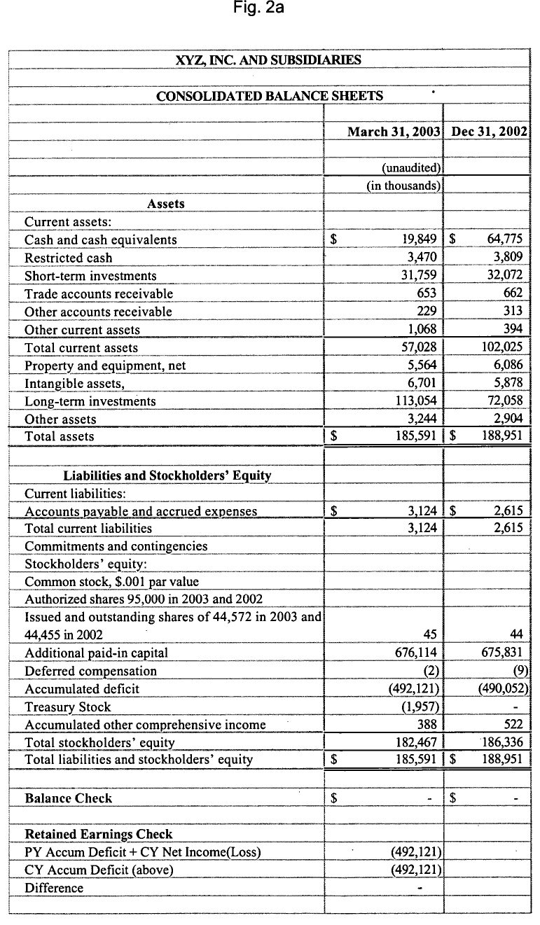

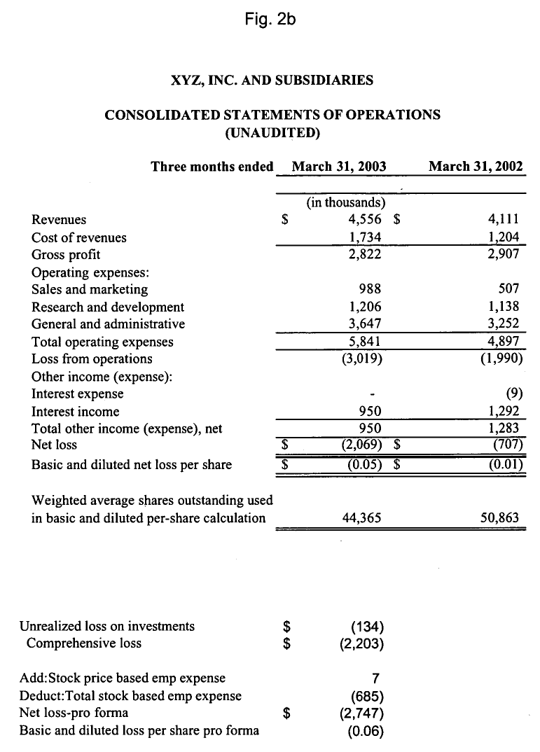

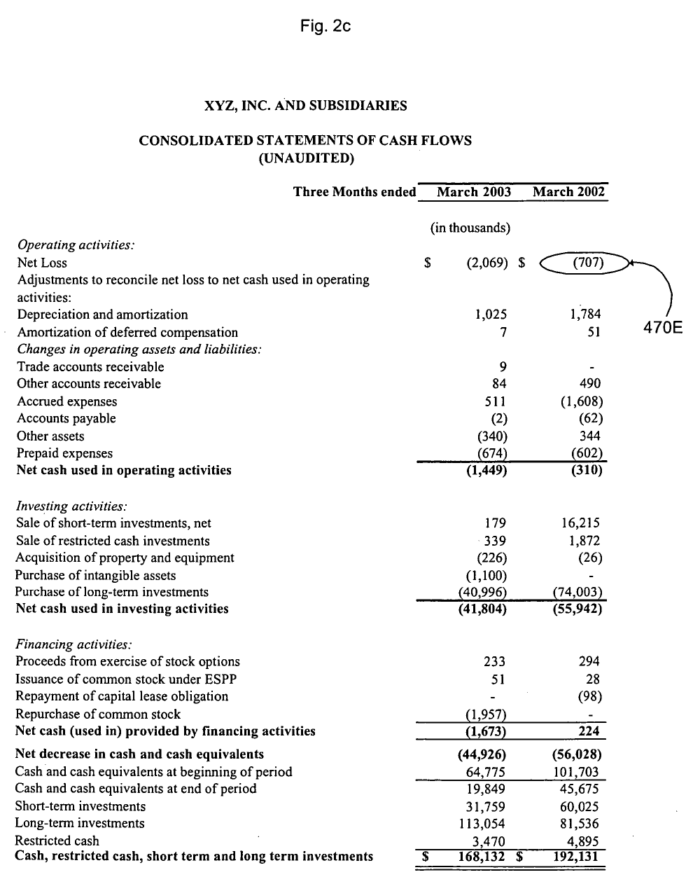

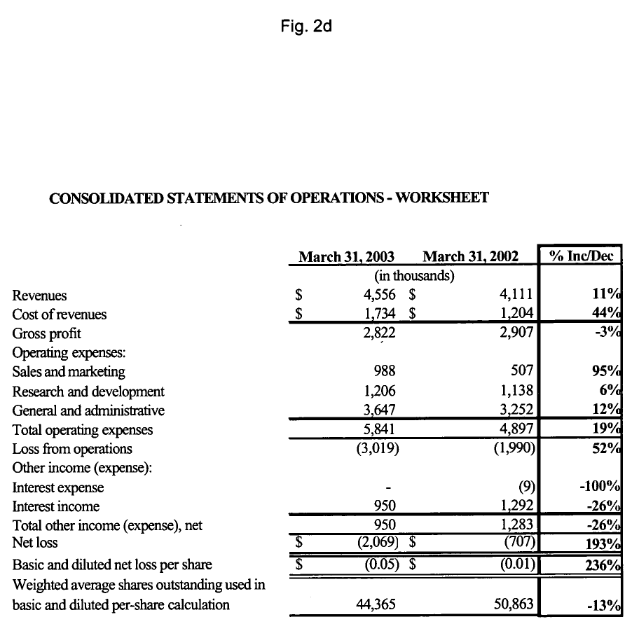

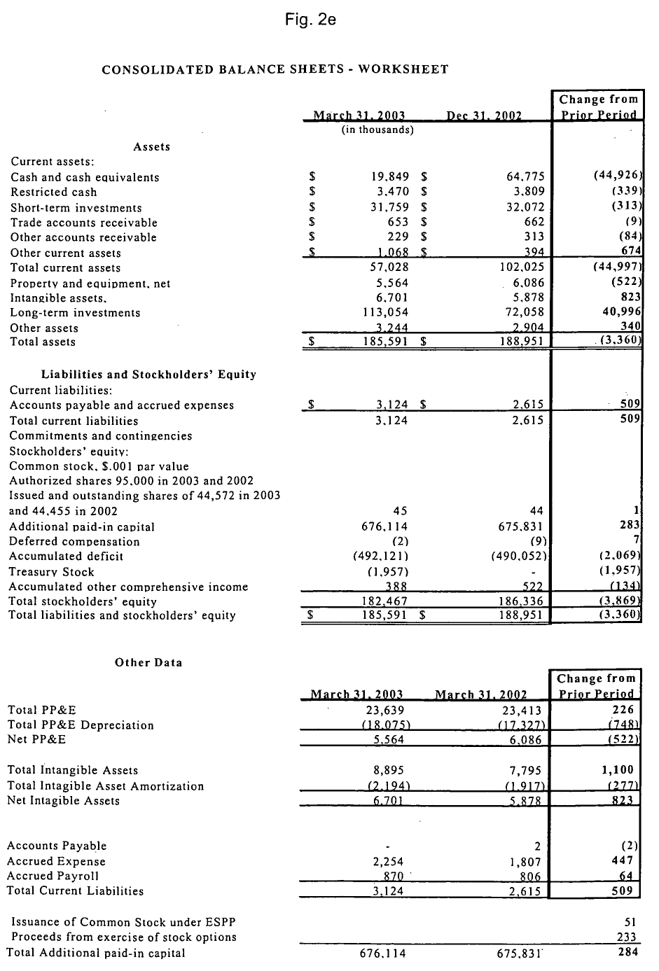

Next, the financial data is manually input into a text document to accommodate the footnotes and other sections (action block 70). Next, footnotes and other supplemental text are incorporated during the reporting process (action block 80). These sections offer explanations and supplemental information about the financial data. For example, one particular supplemental section is referred to as the Management's Discussion and Analysis of Financial Condition and Results of Operations (“MD&A”). In addition to the textual explanations, these sections also contain a significant amount of numerical data derived from the financial statements/reports that are manually calculated, formatted, and inputted into the statements. For the example financial data shown in FIGS. 2(a)-(c), an excerpt from a corresponding MD&A regarding “revenue” may read:

### RESULTS OF OPERATIONS

Revenue. Revenue is derived primarily from two sources: (1) service fees charged to customers and (2) other revenue, consisting of on-line store revenue, advertising revenue from controlled access advertising to our existing customer base, and revenue from the direct sale of consumables.

Revenue for the quarter ended Mar. 31, 2003 was up 11% year over year to $4.6 million from $4.1 million in the first quarter ending Mar. 31, 2002, and up 1% sequentially from $4.5 million in the fourth quarter ending Dec. 31, 2002 primarily due to continued strong product sales through our on-line store.
Note that the numerical data in this MD&A excerpt was derived from the Income Statement, or Consolidated Statements of Operations, shown in FIG. 2b.

A complete set of audited financial statements, therefore, generally includes, as mentioned above, a balance sheet, an example of which is shown in FIG. 2a, an income statement, an example of which is shown in FIG. 2b, a cash flow statement, an example of which is shown in FIG. 2c, an equity statement (not shown), and a set of footnotes and other required text.

The financial data (data block 30) is therefore manually merged with the footnotes and supplemental sections, to form a single document (action block 90). Then, the financial data and calculations are reviewed throughout the document (action block 100). If there is an error or a change that needs to be made (decision block 110), then there are typically two ways of making the change (decision block 160): (1) by processing the change through the accounting software package (action block 170), which then creates the need to regenerate and recalculate all the financial data 30 (action block 20), or (2) by changing the values directly on the financial statements/reports (action block 180). Either way, all sections of the documents are manually reviewed and revised and the financial statements/reports are manually recalculated (action block 100—or, in some cases, the whole process—is repeated again, i.e., action block 20). If no change is necessary or if all the necessary changes and revisions have been made (decision block 120), then the document(s) may be sent to a commercial printer to be published in a final, SEC-compatible format (action block 140). But, before the document(s) are sent, the document(s) are reviewed again at the commercial printer, and if there is an error or a change that needs to be made (decision block 130), the documents are once again revised (action block 180), reviewed, and recalculated (action block 100). As mentioned, because the financial data is extensively interdependent, revising the document(s) and ensuring that the data throughout the document(s) is consistent and accurate are tedious and laborious tasks. It is common for action blocks 100 to 180 or action blocks 20 to 180 to be repeated fifteen to twenty times during the audit or reporting process.

After the documents are finalized at the commercial printer, the audited financial statements—if for a public company—are submitted to the Electronic Data Gathering, Analysis, and Retrieval (“EDGAR”) system, which performs automated validation, indexing, acceptance, and forwarding of submissions by companies and others who are required by law to file forms with the U.S. Securities and Exchange Commission (“SEC”). To submit the documents to the SEC, the documents must be converted to an EDGAR format.

If the document(s) are not submitted to a commercial printer, then they may be submitted to another third party, such as management, lenders or the board of directors (action block 150).

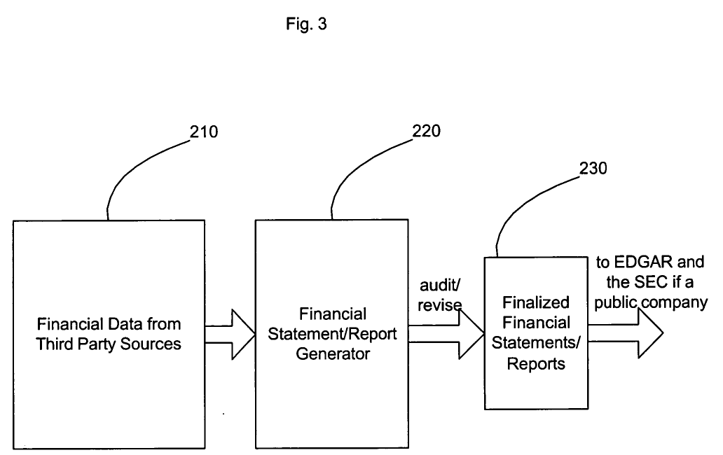

One approach to streamline these processes is shown in FIG. 3. A system 220, having a processor and memory (not shown), may include instructions to extract the financial data 210 from the generated balance sheets and income statements, generate a detailed periodic financial report with appropriate text and/or a complete set of financial statements and corresponding footnotes, and transfer the financial data 210 to the financial statements and/or report. Further, the system 220 may facilitate the auditing/reporting process and, for a public company, generate and convert an audited set of financial statements 230 into EDGAR format for submission to the SEC. The system 220 also may generate the final document to conform with emerging XBRL reporting standards.

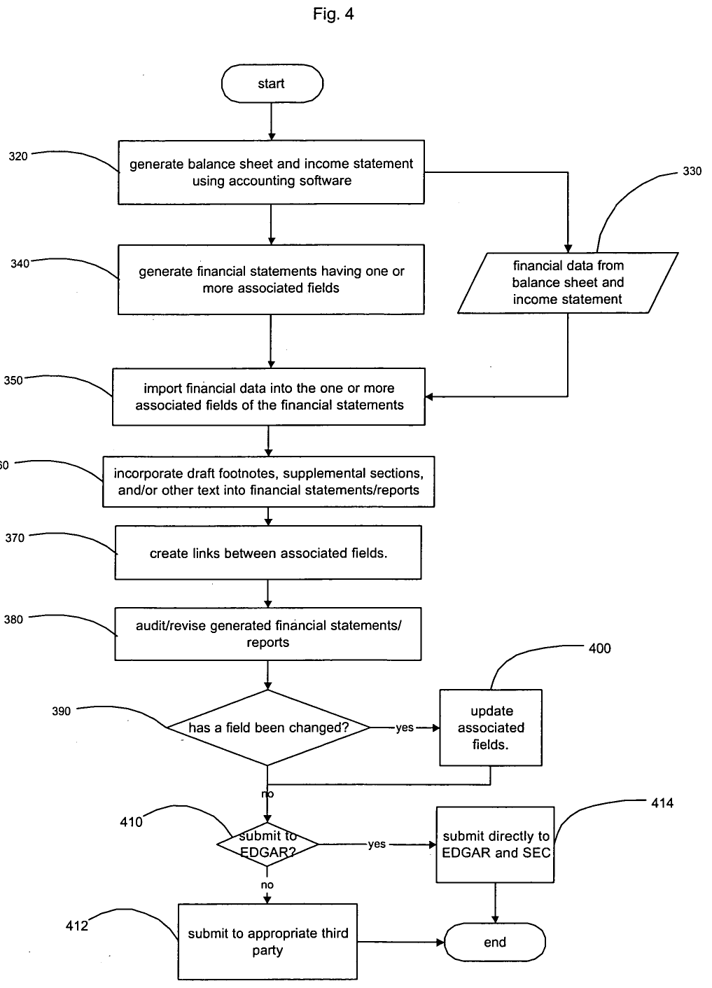

The operation of the system 220 is illustrated in FIG. 4. The system 220 may extract financial data 330 from one or more balance sheets and one or more income statements generated by an accounting software package such as the commercially available packages mentioned above (action block 320). As can be appreciated by one of ordinary skill in the art, the system 220 may directly interface with one or more accounting software packages to automatically extract the data, thus minimizing the need for user intervention. For example, the system 220 may extract data from known data fields or known locations within output(s) generated by the one or more software packages. Alternatively, financial data 330 may be extracted from one or more reports or other output previously generated by the system 220. Such financial data and output can then be consolidated to compile an aggregate report.

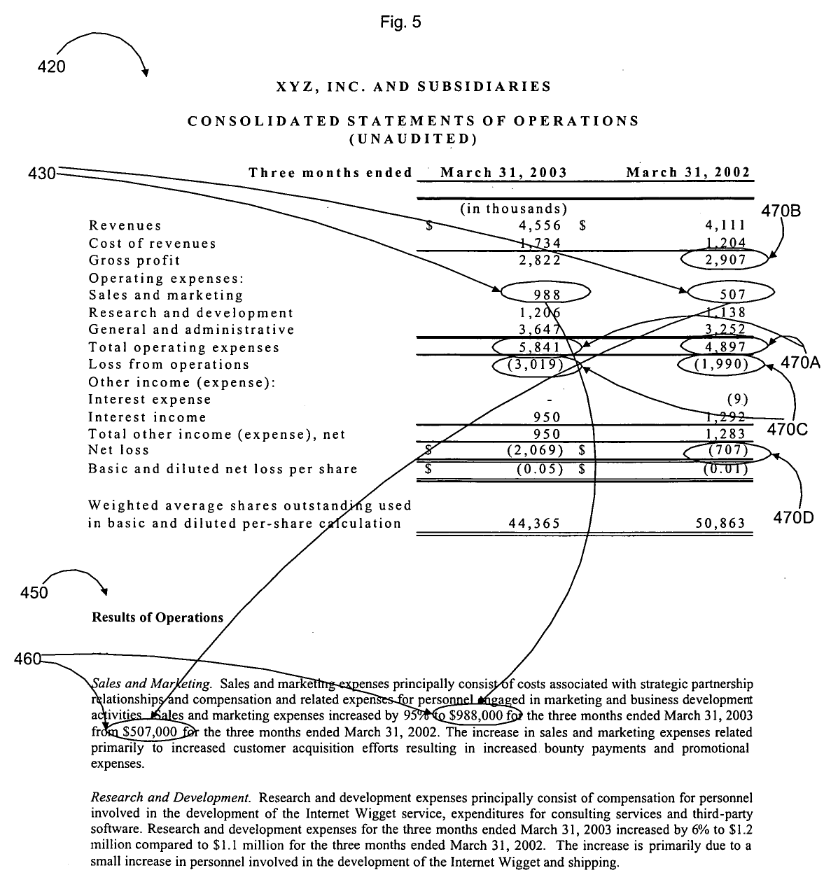

The system 220 may then generate a consolidated balance sheet and a consolidated income statement, examples shown in FIGS. 2a and 2b respectively (action block 340). Further, the system 220 may generate other financial statement components, such as cash flow and equity statements. These statements may be derived from one or more reporting templates, which may have predefined fields and formats. The user may access these predefined templates from within the system, or the user may create any or all of the financial statement components from a blank template. Further, the system 220 implements data fields associated with the extracted financial data 330 (action block 340). For example, turning to FIG. 5, each of the monetary values shown in the “Consolidated Statements of Operations” 420 represents a data field, e.g., under the Mar. 31, 2002 column, the “Gross profit” data field 470B has a value of $2,907 (in thousands), and the “Total operating expenses” data field 470A has a value of $4,897 (in thousands).

Next, the extracted financial data 330 is imported into the associated data fields (action block 350), including information such as company name, headings, and appropriate period dates. Further, for data fields that require values calculated from the financial data 330, the system 220 performs the necessary calculations. For example, turning to FIG. 5, the “Loss from operations” data field 470C, which has a value of ($1,990) (in thousands), requires the subtraction of the “Total operating expenses” data field 470A, $4,897 (in thousands), from the “Gross profit” data field 470B, $2,907 (in thousands). Also, the “Net loss” data field 470D, which has a value of ($707) (in thousands), requires the subtraction of the “Total operating expenses” data field 470A from the “Total other income” data field, which has a value of $1,283 (in thousands). The “Net loss” data field 470D is not only located in the “Consolidated Statements of Operations” but is also located in the “Consolidated Statements of Cash Flows”, data field 470E, shown in FIG. 2c. The system 220 performs these calculations and places the results in the proper data fields, whether they are within the same section or in a different section. If particular values are not present, then a default set of values may be configured and utilized, such as values for days/year, hours/year, or days/month. Defaults may be overridden or customized at any time.

Next, the system 220 incorporates draft footnotes and other supplemental or required text, such as the MD&A 450, into the set of financial statements/reports, and implements appropriate data fields in the appropriate locations of the draft footnotes and supplemental sections (action block 360). For example, turning to FIG. 5, the system 220 implements data fields 460 in the MD&A 450, within the text under the “Results of Operations” section. The footnotes and supplemental sections may be derived from templates based on Financial Accounting Standards Board (“FASB”) and SEC criteria and/or may be extracted by the system 220 from one or more databases of public company filings. The system 220 may also consolidate various reporting segments, and therefore, the financial data may also be extracted by the system 220 from one or more databases within the system 220 that retrieve and store divisional reports. With regard to the footnotes, the numbering of the footnotes may be controlled by the system 220. Footnotes may be moved around, added, edited, removed, and/or renumbered as appropriate.

Next, the system 220 links associated and interdependent fields together throughout the financial statements, including the footnotes and supplemental sections (action block 370). The system 220 may link the fields with or without user intervention. Data fields from the Balance Sheet may be linked with corresponding data fields in the Income Statement, the Equity Statement, the Cash Flow Statement, and the footnotes and supplemental sections. For example, turning to FIG. 5, the “Sales and marketing” data fields 430 in the “Consolidated Statements of Operations” 420, $988 and $507 (in thousands) respectively, are linked to associated data fields 460 within the “Results of Operations” section of the MD&A 450. In addition, data fields 430 are also linked to data fields 470A, which are linked to data fields 470C. Thus, if data fields 430 are changed, corresponding data fields 460, 470A, and 470C are updated as well. Further, data fields 470C are linked to data fields 470D, which are linked to data fields 470E in the “Consolidated Statements of Cash Flows”, shown in FIG. 2c. In addition, the system 220 may be configured to notify the user of all the data fields linked to the changed data field, thus notifying the user of which data fields will be affected by the change. For each linked data field, a user may be able to view and verify the source of the link. Moreover, a user may be able to configure the desired format for each data field, e.g., whether to show whole numbers or show decimal values or whether to round numbers up or down.

After the links have been created (action block 370), an auditor or user may continue to review and further audit or revise the financial statements and/or reports (action block 380). If a field has to be changed, or if there is an error, (decision block 390), then the user can make the necessary change to that field, and the system 220 will automatically update all corresponding linked fields (action block 400). For example, if the “Sales and marketing” data field 430 having the value of $507 (in thousands) is changed, then the corresponding linked data field 460 is automatically updated. Further, other data fields that will be affected by the change will also be updated, such as the “Total operating expenses” data field 470A, which is the sum of the “Sales and marketing” 430, “Research and development,” and “General and administrative” data fields. Further, because data field 430 is changed, the system 220 will also update the calculation in data field 470C. Accordingly, the system will also update the calculation in data field 470D and data field 470E of the “Consolidated Statements of Cash Flows”, shown in FIG. 2c. Since it may be necessary for many third party users to access the system, a collaboration tool may be embedded within the system, allowing multiple users to access the system simultaneously based on user-defined permissions and codes.

Optionally, threshold values may be established such that if the system 220 detects that the value of a particular data field has reached a threshold, the levels and nature of which are determined by the individual user, an alarm is triggered. In addition, the system 220 may be able to determine whether calculations and/or values are out of balance and/or do not “foot.” Each financial statement, footnote, and/or supplemental section may include a status window or status indicator which informs a user as to when changes were last made to each statement, footnotes, and/or supplemental section as well as the completion status of each. For example, statuses may include “not yet started”, “in-process”, or “final”. Utilizing the status feature may also allow users to generate a report indicating what numbers and/or values changed in the course of compiling the document, thereby enabling management to more effectively analyze and further streamline the report generation process. Further, on a user-controlled frequency, the system 220 may save all data in a single version or in multiple versions, where each version may be accessed by the user. If the data is saved in multiple versions, each version may be marked with a time stamp.

With the system 220, a user compiling and/or reviewing the financial statements/reports can bypass the iterations and manual searches previously described. Once a data field is changed, all the associated, interdependent, linked, and corresponding data fields are updated automatically as well (action block 400). After the financial statements/reports have been audited, revised and/or updated, the system 220—if for a public company (decision block 410)—may convert the financial statements to the EDGAR format for submission to the SEC (action block 414). The submission may be electronic and the final document may be stored in a read-only format for future review and reference. If the documents are not for a public company, then the final document may be submitted to the appropriate third party recipient (action block 412). The financial statements/reports may further be transferred electronically to other parties, such as clients, for further review. Further, the financial reporting methods utilized to compile the report may be compared to a “best practices” industry standard, in order to facilitate and identify conformance to industry regulations, lender requirements and management/board standards. Also, the data within the financial statements may be saved and information such as a corporation's dates, balances, and related financial information may be “rolled forward” in preparation for a new set of financial statements for the following reporting period. Moreover, the data, footnotes, and supplemental sections may be presented as charts and/or graphs.

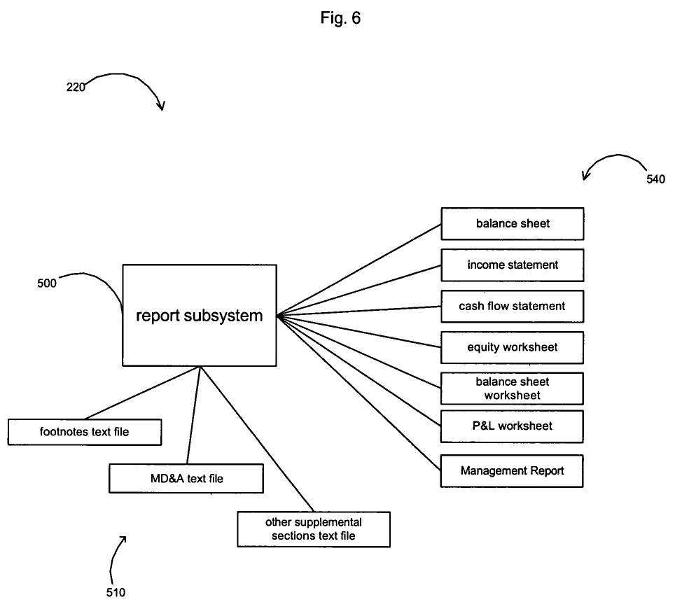

As can be appreciated by one of ordinary skill in the art, the different financial statements described above may be presented as a plurality of worksheets, such as Microsoft Excel® worksheets for example. Further, the footnotes, MD&A's, and other supplemental sections and required text may be presented as text files or word files, such as Microsoft Word® files. These worksheets and files may be exploited as objects by an object-oriented program developed with an object-oriented programming language such as C*, C++ or Java. Turning to FIG. 6, a diagram depicting such a program is shown. A financial statement generator 220 may include a report subsystem 500 which creates and manages a plurality of worksheet objects 540 and text file objects 510. The data fields described above may be created and inserted into each of the objects. Generally, the data fields are implemented in worksheet objects 540 as cells, and for text files, the data fields may be implemented as custom smart tags. The subsystem 500 may create these objects 540, implement appropriate data fields as cells and smart tags, and then load the values of the cells and smart tags with financial data 330 extracted from the accounting software or with values calculated from the financial data 330, as described above. Further, the subsystem 500 allows links to be established between associated cells and smart tags within the different objects. A user may programmatically identify and insert appropriate links, and/or the subsystem 500 may be configured to establish the links automatically. After the links have been established, then as described above, if the value of a particular field changes, then all the linked data fields will be updated accordingly.

As suggested above, some of the values of the data fields are direct transfers from the extracted financial data, such as the “Cash and cash equivalents” data fields in FIG. 2a. However, some data fields require further calculations. For example, some data fields, such as the “Total current assets” data fields in FIG. 2a, require the summation of the values in the “Cash and cash equivalents”, “Restricted cash,” “Short-term investments,” “Trade accounts receivable,” “Other accounts receivable,” and “Other current assets” data fields. If the result of a calculation performed can be placed directly into a data field, then the data field may be configured to perform the calculation, which is generally referred to as a 1st order calculation.

If, however, a calculation produces one or more interim results that cannot be placed directly into one or more data fields, then it may be desirable to utilize one or more interim data fields to allow a user to review the interim calculations. Further, in some cases, it may be desirable to produce data values that are typically not present in the balance sheet, income statement, cash flow statement, or equity statement, but that are derived from the values in those statements. Such values may be helpful for a user during the review process, and such values may be used in the footnotes, MD&A, and other supplemental sections. For example, as shown in FIG. 2d, these values may include percentage increase or decrease in “Revenues” or “Gross profit.” These types of calculations may be referred to as 2nd order calculations, and these data values may be included in supplemental worksheets, such as (turning to FIG. 6) an income statement, or “Consolidated Statements of Operations,” worksheet (example of which is shown in FIG. 2d) and balance sheet worksheet (example of which is shown in FIG. 2e). Generally, it may be desirable to lock the ability to edit values derived from 2nd order calculations, thus requiring a user to edit values from 1st order calculations only.

The statement generator 220 may further include a help feature, to assist the user regarding the various features and functions of the generator 220, as well as a wizard-type function, which provides a set of screens or questions that assist in the creation of a new document. In addition, the generator 220 may email documents to various parties for review and record a log of what information was sent, what version, when, and to whom the information was sent. The generator 220 may also allow remote access by various types of third party users (e.g., lawyers, auditors, and board members); however, to monitor such access, the generator 220 may include a security system which grants or denies permission and/or access to various functions and system objects within the generator 220. Further, the security system may lock and unlock the various functions and system objects.

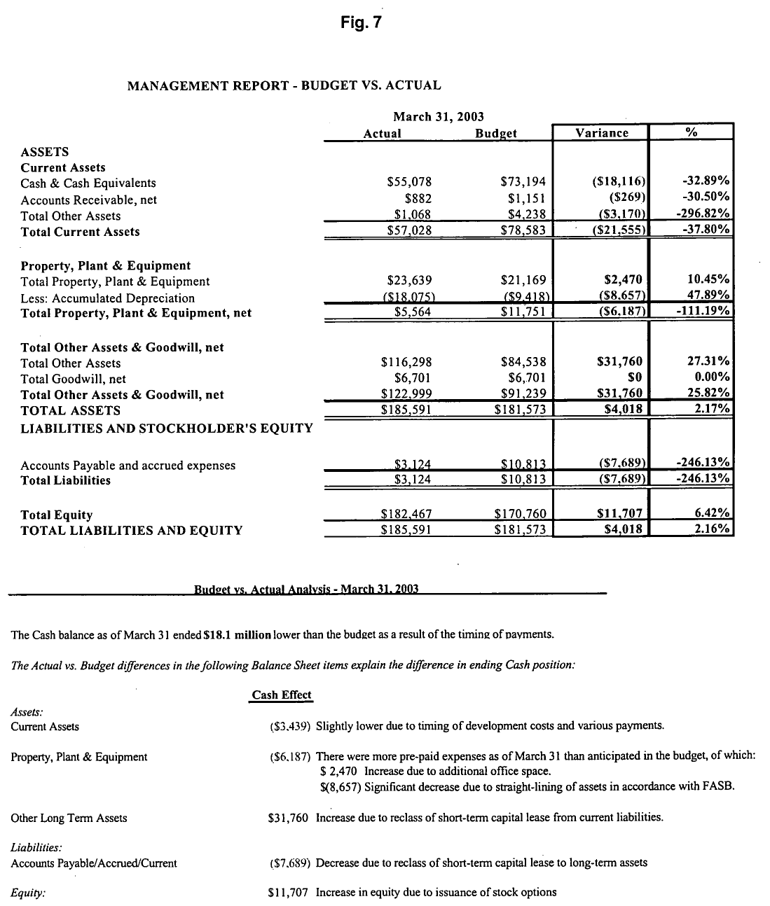

As mentioned above, the principles described above are equally applicable to audited and unaudited financial reports as well as audited and unaudited financial statements. An example of a typical financial report is shown in FIG. 7, which reflects the same (actual) values as the balance sheet shown in FIG. 2a.

As a recap, the following is a list of features that may be included in the statement generator 220 described above:

Linking of Values Throughout Document

The system 220 may combine the math functionality of a spreadsheet with the text processing functionality of a word processor to compile and generate audited and unaudited financial statements and reports. The data links remain active throughout the preparation of the document, i.e., if any changes are made to the numbers or any linked value, all corresponding links update with the new data.

Input Sheets—Financial Statements

Location where financial data, budget and/or actual, is extracted. When user attempts to edit a value that originates from the financial statements, user is taken to the source of that value and given opportunity to make changes there. User is also informed that making this change will edit all occurrences of this value in the document.

Input Sheets—Computed Values

Location where computations are performed, using data from financial statements and elsewhere. Since the values used in the computations are linked, they are updated instantly with any changes. These values cannot be directly edited; user is prompted to change value directly on the financial statement input sheet instead.

Cash Flow and Equity Statement Creation

Using the extracted financial data, the cash flow and equity statements are calculated. Subsequently, user can edit and manipulate values to achieve balance.

Data Extraction

By interfacing directly with third party financial sources or other system 220 output, the system 220 extracts the financial data from the software package directly to the input sheets.

Source Identifier

User right-clicks on linked value to view and/or verify the source of the link.

Auto Format

Upon inserting a link, user is prompted to select the desired format of the designated value.

Balance Alarms

System 220 notifies user when certain statements, balances and/or calculations are out of balance.

Company-Specific Values

System 220 may default to certain values, according to the customized specifications of each user (i.e. Days/Year, Hours/Year, Days/Month).

Roll Forward

System adjusts the dates, balances and related financial information when preparing a new set of financial statements/reports for a new reporting period.

Resource Locator

Provides link to database of public company filings and management reports from which data and/or footnotes can be extracted.

Charts/Graphs

Once all the required numbers and footnotes have been completed, the user has the option to chart and/or graph any of the information which has been input.

Status Window

Informs user as to when changes were last made to the financial data as well as the completion status of each section of the document.

Help Function

Provides help throughout the preparation of the document to assist the user regarding the system's various features and functions.

Override Capability

Gives the user the capability at all times to override any of the default presentations or options such that the document is always customized according to the needs and desires of the individual user.

Auto Setup

Upon registering as a user and extracting financial data, system 220 automatically inserts company name, headings, appropriate period dates and related financial data into document.

Auto Save

On a user-controlled frequency, system 220 may save all data.

Reporting Templates

System 220 allows user to select predefined reporting template from which to begin drafting document.

Versioning

User can save each edited version of document, to access and review as necessary, before finalizing.

Report Creation Wizard

Provides a set of screens/questions that assist in the creation of a new document.

Filing Database

Prior, published documents are saved in read-only format for future review and reference.

Forced Rounding

Ability for user to force the rounding up or down of a given individual value.

Footnote Numbering

System 220 may control the numbering of the footnotes within the document. As footnotes are moved around, edited, added or removed the system renumbers them accordingly.

System Security

Permissions supported for various functions within the system 220, which are granted to users and control individual access rights to system objects and functions.

Locking

Anything in the system 220 can be locked and unlocked. Locking and unlocking is permission-based.

Timestamp Locks

System 220 timestamps and user-stamps all changes in lock status of a given object.

EDGAR Reporting Format

Final document is produced in proper EDGAR/SEC-compatible format.

XBRL Compliant

System 220 adheres to emerging XBRL standards.

Email Export

Enables user to email the document to any address. Later, as a report, provides information on when, to whom and what version was sent.

Conformance to “Best Practice” Standards

Compares financial reporting methods to a “best practice” industry standard that facilitates and identifies conformance to industry regulations and management/board standards.

FASB and SEC Footnote Generator

User has ability to access templates for footnotes based on new FASB and SEC criteria.

Covenant Alarms

System 220 generates alarms when current covenants are violated or are approaching unacceptable levels.

Consolidation of Reporting Segments

System 220 retrieves, imports and stores financial data from reporting segments (i.e. divisions, subsidiaries, etc.). User can then select segments to compile and generate a consolidated report.

Remote Access

Enables “off-site” users to access the system 220 from a remote location.

Final Status Report

Enables users to review and analyze the changes that were made to the report throughout the compilation process. This allows users to detect patterns and inefficiencies and to review the numerous revisions quickly and easily.

Collaboration Tool

Enables multiple parties to access, review, and/or revise the data within system 220 simultaneously.

Note that the features previously described may be utilized in concurrence with the system generator 220 or as individual components, upon which or with which various forms of reporting may occur.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

1. A method for generating a set of financial statements, comprising the steps of:
extracting financial data from one or more financial sources;
generating one or more financial statements having a plurality of fields, each field having one or more associated fields;
importing the extracted financial data into the plurality of fields;
creating one or more links between each of the plurality of fields and each field's one or more associated fields; and
if any of the plurality of fields change, then updating the changed field's one or more associated fields.

2. The method of claim 1, wherein the set of financial statements is audited.

3. The method of claim 1, wherein the set of financial statements is unaudited.

4. The method of claim 1, wherein the plurality of fields are located among a plurality of documents.

5. The method of claim 4, wherein the plurality of documents include spreadsheets and text-based documents.

6. The method of claim 1, further comprising the step of converting the financial statements into EDGAR format.

7. The method of claim 1, further comprising the step of directly interfacing with a third party accounting software package.

8. The method of claim 1, further comprising the step of incorporating draft footnotes and supplemental sections into the set of financial statements.

9. The method of claim 1, further comprising the step of generating one or more worksheets having values from 2nd order calculations.

10. The method of claim 1, wherein the one or more financial statements includes a balance sheet, a statement of operations, a cash flow statement, and an equity statement.

11. The method of claim 1, further comprising the step of directly interfacing with one or more third party financial sources.

12. A computer program product that includes a computer-usable medium having a sequence of instructions which, when executed by a processor, causes said processor to execute a process for generating a set of financial statements, said process comprising the steps of:
extracting financial data from one or more financial sources;
generating one or more financial statements having a plurality of fields, each field having one or more associated fields;
importing the extracted financial data into the plurality of fields;
creating one or more links between each of the plurality of fields and each field's one or more associated fields; and
if any of the plurality of fields change, then updating the changed field's one or more associated fields.

13. The computer program product of claim 12, wherein the set of financial statements is audited.

14. The computer program product of claim 12, wherein the set of financial statements is unaudited.

15. The computer program product of claim 12, further comprising the step of converting the financial statements into EDGAR format.

16. The computer program product of claim 12, further comprising the step of directly interfacing with a third party accounting software package.

17. The computer program product of claim 12, further comprising the step of incorporating draft footnotes and supplemental sections into the set of financial statements.

18. The computer program product of claim 12, further comprising the step of generating one or more worksheets having values from 2nd order calculations.

19. The computer program product of claim 12, wherein the one or more financial statements includes a balance sheet, a statement of operations, a cash flow statement, and an equity statement.

20. The computer program product of claim 12, further comprising the step of directly interfacing with one or more third party financial sources.

21. The computer program product of claim 12, wherein the plurality of fields are located in a plurality of documents.

22. The computer program product of claim 21, wherein the plurality of documents include spreadsheets and text-based documents.

23. A system for generating a set of financial statements, comprising:
a means for extracting financial data from one or more financial sources;
a means for generating one or more financial statements having a plurality of fields, each field having one or more associated fields;
a means for importing the extracted financial data into the plurality of fields;
a means for creating one or more links between each of the plurality of fields and each field's one or more associated fields; and
a means for updating the changed field's one or more associated fields, if any of the plurality of fields change.

24. The system of claim 23, wherein the set of financial statements is audited.

25. The system of claim 23, wherein the set of financial statements is unaudited.

26. The system of claim 23, further comprising a means for converting the financial statements into EDGAR format.

27. The system of claim 23, further comprising a means for directly interfacing with a third party accounting software package.

28. The system of claim 23, further comprising a means for incorporating draft footnotes and supplemental sections into the set of financial statements.

29. The system of claim 23, further comprising a means for generating one or more worksheets having values from 2nd order calculations.

30. The system of claim 23, wherein the one or more financial statements includes a balance sheet, a statement of operations, a cash flow statement, and an equity statement.

31. The system of claim 23, further comprising the step of directly interfacing with one or more third party financial sources.

32. A method for generating financial reports, comprising the steps of:
extracting financial data from one or more financial sources;
generating one or more financial reports having a plurality of fields, each field having one or more associated fields;
importing the extracted financial data into the plurality of fields;
creating one or more links between each of the plurality of fields and each field's one or more associated fields; and
if any of the plurality of fields change, then updating the changed field's one or more associated fields.

33. The method of claim 32, wherein the financial reports are unaudited.

34. The method of claim 32, further comprising the step of directly interfacing with one or more third party financial sources.

35. The method of claim 32, further comprising the step of directly interfacing with one or more third party software packages.

36. The method of claim 32, further comprising the step of incorporating supplemental text into the financial reports.

37. A method for generating a set of financial statements, comprising the steps of:
extracting financial data from one or more financial sources;
generating one or more financial statements having a plurality of fields, each field having one or more associated fields;
importing the extracted financial data into the plurality of fields;
creating one or more links between each of the plurality of fields and each field's one or more associated fields, wherein each linked associated field of a particular field is automatically updated when the particular field is changed.
